(19) United States
(12) Patent Application Publication
(10) Pub. No.: US 2026/0327385 A1
(43) Pub. Date: Oct. 22, 2026

(54) SYSTEMS AND METHODS FOR CURING POLYMER MATERIALS

(71) Applicant: The Boeing Company, Arlington, VA (US)

(72) Inventors: Garrett Blue, Columbus, MS (US); Quinten Henricks, Dublin, OH (US); Devin R. Jensen, Morgantown, WV (US)

(73) Assignee: The Boeing Company, Arlington, VA (US)

(21) Appl. No.: 19/184,101

(22) Filed: Apr. 21, 2025

(51) Int. Cl. C08J 3/24; B29C 64/106; B29C 64/393; B29K 33/04; B29K 307/04; B33Y 10/00; B33Y 50/02; B33Y 80/00; C08K 3/04

(52) U.S. Cl. CPC C08J 3/24; B29C 64/106; B29C 64/393; B33Y 10/00; B33Y 50/02; B33Y 80/00; C08K 3/04; B29K 2033/04; B29K 2307/04; C08J 2333/04

(57) ABSTRACT

A method for curing a polymer material includes step of: (1) sealing the polymer material within an envelope; (2) reducing an interior pressure within the envelope to a predetermined negative pressure; (3) inducing flow of the polymer material by increasing an exterior pressure to a predetermined flow pressure and a material temperature to a predetermined flow temperature; (4) curing the polymer material by increasing the exterior pressure to a predetermined cure pressure and the material temperature to a predetermined cure temperature and maintaining for a predetermined cure period; (5) degassing the polymer material by increasing the exterior pressure to a predetermined degas pressure and the material temperature to a predetermined degas temperature and maintaining for a predetermined degas period; and (6) cooling the polymer material.

### FIELD

The present disclosure relates generally to polymer manufacturing and, more particularly, to systems and methods for curing polymer materials and, more particularly, to systems and methods for curing thermoset products of reactive additive manufacturing.

### BACKGROUND

Polymer materials are widely used across industries including aerospace, automotive, construction, and electronics due to their exceptional mechanical strength, thermal stability, and chemical resistance. Conventional curing methods for polymer materials have been well-established. However, despite their widespread use, traditional curing techniques present various limitations related to porosity, thermal expansion, thermal degradation, and surface tolerances. Accordingly, those skilled in the art continue with research and development efforts in the field of polymer curing.

### SUMMARY

Disclosed are examples of a method for curing a polymer material, a system for curing a polymer material, and a polymer structure. The following is a non-exhaustive list of examples, which may or may not be claimed, of the subject matter according to the present disclosure.

In an example, the disclosed method includes step of: (1) sealing a polymer material within an envelope; (2) reducing an interior pressure within the envelope to a predetermined negative pressure; (3) inducing flow of the polymer material by increasing an exterior pressure to a predetermined flow pressure and a material temperature to a predetermined flow temperature; (4) curing the polymer material by increasing the exterior pressure to a predetermined cure pressure and the material temperature to a predetermined cure temperature and maintaining for a predetermined cure period; (5) degassing the polymer material by increasing the exterior pressure to a predetermined degas pressure and the material temperature to a predetermined degas temperature and maintaining for a predetermined degas period; and (6) cooling the polymer material.

In an example, the disclosed system includes an envelope configured to receive a polymer material. The system includes a negative pressure generator configured to control an interior pressure within the envelope. The system includes a thermostatic device configured to control a material temperature of the polymer material. The system includes a positive pressure generator configured to control an exterior pressure surrounding the envelope. The system includes a controller programmed to control the negative pressure generator, the thermostatic device, and the positive pressure generator and cause to: reduce the interior pressure to a predetermined negative pressure; increase the exterior pressure to a predetermined flow pressure and the material temperature to a predetermined flow temperature to induce flow in the polymer material; increase the exterior pressure to a predetermined cure pressure and the material temperature to a predetermined cure temperature and maintain for a predetermined cure period to cure the polymer material; increase the exterior pressure to a predetermined degas pressure and the material temperature to a predetermined degas temperature and maintain for a predetermined degas period to degas the polymer material; and reduce the exterior pressure and the material temperature to cool the polymer material.

In an example, the disclosed polymer structure includes a polymer material cured by: sealing the polymer material within an envelope; reducing an interior pressure within the envelope to a predetermined negative pressure; inducing flow of the polymer material by increasing an exterior pressure to a predetermined flow pressure and a material temperature to a predetermined flow temperature; curing the polymer material by increasing the exterior pressure to a predetermined cure pressure and the material temperature to a predetermined cure temperature and maintaining for a predetermined cure period; degassing the polymer material by increasing the exterior pressure to a predetermined degas pressure and the material temperature to a predetermined degas temperature and maintaining for a predetermined degas period; and cooling the polymer material.

Other examples of the method, the system, and the polymer structure will become apparent from the following detailed description, the accompanying drawings, and the appended claims.

### BRIEF DESCRIPTION OF THE DRAWINGS

FIG. 1 is a flow diagram of an example of a method for curing a polymer material;

FIGS. 2A and 2B are a schematic block diagram of an example of a system for curing a polymer material;

FIG. 3 is a chart depicting an example of a cure cycle according to the method;

FIG. 4 is a graph depicting an example of a cure cycle according to the method;

FIG. 5 is a block diagram of an example of a data processing system;

FIG. 6 is a schematic illustration of an example of an aircraft; and

FIG. 7 is a flow diagram of an example of an aircraft manufacturing and service method.

### DETAILED DESCRIPTION

The following detailed description describes methods and systems for curing polymer materials, such as thermoset materials, that produce cured polymer structures having desired physical characteristics or properties. Examples of the methods and systems described herein beneficially provide an increase in crosslinking, a reduction in porosity, and removal of excess constituent ingredients remaining after chemical reactions. In a particular example, the methods and systems described herein can be used to cure a multicomponent reactive thermoset formed using additive manufacturing techniques.

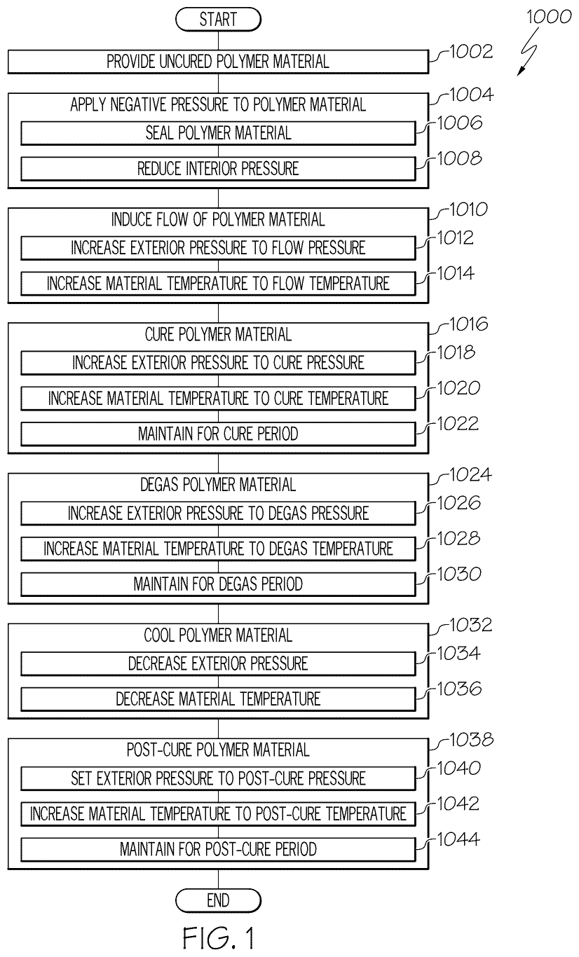

Referring now to FIG. 1, by way of examples, present disclosure is directed to method 1000 for curing polymer material 210. The following are examples of method 1000, according to the present disclosure. Examples of method 1000 include a number of elements, steps, operations, or processes or combinations thereof. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein. The elements, steps, operations, or processes need not necessarily be performed in the specific order(s) they are described and/or depicted.

As will be described in more detail below, examples of method 1000 represent various implementations of a cure cycle or cure process for polymer material 210. In one or more examples, the cure cycle or process of method 1000 includes an initial flowing stage or phase (e.g., flow phase 310), a main curing stage or phase (e.g., cure phase 320), and a subsequent degassing stage or phase (e.g., degas phase 330). In one or more examples, the cure cycle or process according to method 1000 includes a subsequent cooling stage or phase (e.g., cool phase 340). In one or more examples, the cure cycle or process of method 1000 also includes a final post-curing stage or phase (e.g., post-cure phase 360). In one or more examples, polymer material 210 is initially provided in an uncured state, also referred to herein as uncured polymer material 220. In these examples, the term “uncured” refers to a polymer material that has not yet undergone the curing process, or has only partially done so, or, for example, has not fully hardened or achieved its final properties. Following the cure cycle, according to method 1000, the polymer material 210 is in a cured state, also referred to herein as cured polymer material 224. In these examples, the term “cured” refers the polymer material that has undergone the curing process, for example, transforming it from a liquid, semi-liquid, or pliable state to a solid, stable, or developed form. As such, depending on context, polymer material 210 may be used to refer to uncured polymer material 220 or cured polymer material 224.

In one or more examples, polymer material 210 includes thermoset material 212. In one or more examples, polymer material 210 includes vinyl ester resin 214. In one or more examples, polymer material 210 also includes reinforcement material 216, such as chopped carbon 226. However, in other examples, polymer material 210 can include various other suitable materials.

In one or more examples, the method 1000 includes, at 1002, a step of providing uncured polymer material 220 (e.g., polymer material 210 in uncured state). In one or more examples, uncured polymer material 220 is in the form of a fabricated polymer part in an uncured state, also referred to herein as uncured polymer part 222. In one or more examples, uncured polymer part 222 is made using additive manufacturing apparatus 190 or is a product of an additive manufacturing process. In one or more examples, uncured polymer part 222 is made using a reactive additive manufacturing apparatus 192 or is a product of a reactive additive manufacturing (“RAM”) process.

In one or more examples, the method 1000 includes, at 1004, a step of applying predetermined negative pressure 122 to uncured polymer material 220 (e.g., polymer material 210 in uncured state), such as uncured polymer part 222 fabricated by RAM process. In one or more examples, method 1000 includes, at 1006, a step of sealing (e.g., containing or enclosing) uncured polymer material 220 within envelope 110 and, at 1008, a step of reducing interior pressure 112 within envelope 110 and surrounding uncured polymer material 220 to predetermined negative pressure 122. In one or more examples, predetermined negative pressure 122 is approximately −30 inHg (approximately −1015.9 hPa). In one or more examples, method 1000 includes a step of maintaining predetermined negative pressure 122 within envelope 110 until cooling polymer material 210 (e.g., at 1032).

For the purpose of the present disclosure, interior pressure 112 refers to the pressure or force exerted or acting on polymer material 210 inside of envelope 110 during the curing process, for example, caused by the difference between the external pressure (outside of envelope 110) and the partial vacuum (lowered pressure) inside of envelope 110. Generally, predetermined negative pressure 122 (e.g., vacuum) is applied during curing to ensure quality and performance of a cured polymer material (e.g., polymer structure 200). As examples, application of predetermined negative pressure 122 facilitates removal of air and volatiles, consolidation of material layers, reduction of porosity, and enhanced mechanical properties, control of thickness and shape, among other things.

Generally, envelope 110 includes or refers to any suitable device or structure capable of receiving, enclosing, and sealing uncured polymer material 220 (e.g., uncured polymer part 222) during a curing process. In one or more examples, envelope 110 includes or is made of a flexible, heat resistant, and airtight material. As examples, envelope 110 can be made of a suitable material, such as, but not limited to, nylon, silicone, and the like. Envelope 110 can have any suitable geometry. In one or more examples, envelope 110 is configured (e.g., sized and shaped) to surround, enclose, or encapsulate uncured polymer material 220. In one or more examples, envelope 110 is configured (e.g., sized and shaped) to surround, enclose, or encapsulate uncured polymer material 220 and tooling (e.g., mold, mandrel, etc.), such as upon which uncured polymer material 220 was formed. Envelope 110 facilitates application of uniform pressure and removal of air and/or other volatiles during the curing process. In one or more examples, envelope 110 is sealed around the edges to maintain an airtight boundary. In one or more examples, envelope 110 includes or takes the form of vacuum bagging 114, a vacuum bag, and the like.

In one or more examples, method 1000 includes, at 1010, a step of inducing flow of polymer material 210 (e.g., uncured polymer material 220). In one or more examples, the step of inducing flow represents an initial stage of the disclosed cure cycle before chemical reactions (e.g., cross-linking) occur. Additionally, initially trapped air, gases, or other volatiles are purged from uncured polymer material 220 during this stage or phase. As used herein, inducing flow has its ordinary meaning as understood in the art and can refer to transition to a low-viscosity, fluid state (e.g., liquid or semi-liquid condition) to facilitate movement and distribution of the polymer material.

According to method 1000, inducing flow is achieved by increasing exterior pressure 142 and/or increasing material temperature 132. In one or more examples, method 1000 includes, at 1012, a step of increasing exterior pressure 142 to predetermined flow pressure 144. In one or more examples, method 1000 includes, at 1014, a step of increasing material temperature 132 to predetermined flow temperature 134. In one or more examples, exterior pressure 142 is progressively or incrementally increased to predetermined flow pressure 144 at predetermined pressure rate 166. In one or more examples, material temperature 132 is progressively or incrementally increased to predetermined flow temperature 134 at predetermined temperature rate 168.

In one or more examples, predetermined flow pressure 144 is approximately 60 psi (approximately 413 kPa). In one or more examples, predetermined flow pressure 144 progressively increases from approximately 15 psi (approximately 103 kPa) to approximately 60 psi (approximately 413 kPa) at predetermined pressure rate 166. In one or more examples, predetermined flow pressure 144 steps up, for example, at predetermined pressure rate 166, from approximately 15 psi (approximately 103 kPa), to approximately 30 psi (approximately 206 kPa), to approximately 45 psi (approximately 310 kPa), to approximately 60 psi (approximately 413 kPa).

In one or more examples, predetermined flow temperature 134 is approximately 275 °F (approximately 135 °C). In one or more examples, predetermined flow temperature 134 progressively increases from about room temperature to approximately 150 °F (approximately 65 °C) at predetermined temperature rate 168. In one or more examples, predetermined flow temperature 134 steps up, for example, at predetermined temperature rate 168, from approximately 150 °F (approximately 65 °C), to approximately 200 °F (approximately 93 °C), to approximately 275 °F (approximately 135 °C).

In one or more examples, predetermined pressure rate 166 is approximately 5 psi per minute (approximately 574.56 Pa/s). In one or more examples, predetermined temperature rate 168 is approximately 1 °F per minute (approximately 0.556 °C per minute).

For the purpose of the present disclosure, exterior pressure 142 refers to the external force applied to uncured polymer material 220 during curing to influence properties of polymer material 210. As an example, exterior pressure 142 is the pressure or force exerted or acting on polymer material 210 outside of envelope 110 during the curing process, such as, the pressure external to the envelope 110 (uncured polymer material 220 sealed within envelope 110).

For the purpose of the present disclosure, material temperature 132 refers to the temperature (e.g., internal temperature) of polymer material 210 during the curing process. In one or more examples, material temperature 132 is controlled or influenced by exterior temperature 133. For the purpose of the present disclosure, exterior temperature 133 refers to air temperature external to polymer material 210 (e.g., uncured polymer material 220) during curing.

In one or more examples, method 1000 includes, at 1016, a step of curing polymer material 210 (e.g., uncured polymer part 222). In one or more examples, the step of curing represents the primary cure stage of the disclosed curing process during which significant chemical reactions occur. As used herein, curing in this step has its ordinary meaning as understood in the art and refers to transition from a low-viscosity, fluid state to a solid, cured material, such as via gelation where the polymer material transitions from a liquid to a semi-solid or gel-like state due to the formation of a three-dimensional network of molecular chains through crosslinking where polymer chains form bonds, creating a rigid, three-dimensional network that gives the material its final solid form and properties.

According to method 1000, curing is achieved by further increasing exterior pressure 142 and/or further increasing material temperature 132 and maintaining exterior pressure 142 and material temperature 132 for a predetermined dwell time (e.g., the duration of the main curing stage). In one or more examples, method 1000 includes, at 1018, a step of increasing exterior pressure 142 to predetermined cure pressure 146. In one or more examples, method 1000 includes, at 1020, increasing material temperature 132 to predetermined cure temperature 136. In one or more examples, method 1000 includes, at 1022, a step of maintaining exterior pressure 142 at predetermined cure pressure 146 and maintaining material temperature 132 at predetermined cure temperature 136 for predetermined cure period 162. In one or more examples, exterior pressure 142 is progressively or incrementally increased to predetermined cure pressure 146 at predetermined pressure rate 166. In one or more examples, material temperature 132 is progressively or incrementally increased to predetermined cure temperature 136 at predetermined temperature rate 168.

In one or more examples, predetermined cure pressure 146 is approximately 75 psi (approximately 517 kPa). In one or more examples, predetermined cure pressure 146 progressively increases from approximately 60 psi (approximately 413 kPa) to approximately 75 psi (approximately 517 kPa) at predetermined pressure rate 166.

In one or more examples, predetermined cure temperature 136 is approximately 275 °F (approximately 135 °C). In one or more examples, predetermined flow temperature 134 is maintained while exterior pressure 142 is increased from predetermined flow pressure 144 to predetermined cure pressure 146.

In one or more examples, predetermined cure period 162 is approximately 120 minutes.

In one or more examples, method 1000 includes, at 1024, a step of degassing polymer material 210 (e.g., cured polymer material 224). In one or more examples, the step of degassing represents a subsequent cure stage of the disclosed curing process during which remaining trapped air, gases, and other volatiles are purged from cured polymer material 224. For the purpose of the present disclosure, the terms degassing and degas refer to the escape, release, or removal of trapped gases, vapors, or volatile compounds from polymer material 210, whether by active application of heat, pressure, and/or vacuum or otherwise, and includes outgassing, venting, volatilization, and purging.

According to method 1000, degassing is achieved by further increasing exterior pressure 142 and/or further increasing material temperature 132 and maintaining exterior pressure 142 and material temperature 132 for a predetermined dwell time (e.g., the duration of the subsequent degassing stage). In one or more examples, method 1000 includes, at 1026, a step of increasing exterior pressure 142 to predetermined degas pressure 148. In one or more examples, method 1000 includes, at 1028, a step of increasing material temperature 132 to predetermined degas temperature 138. In one or more examples, method 1000 includes, at 1030, a step of maintaining exterior pressure 142 to predetermined degas pressure 148 and maintaining material temperature 132 to predetermined degas temperature 138 for predetermined degas period 164. In one or more examples, exterior pressure 142 is progressively or incrementally increased to predetermined degas pressure 148 at predetermined pressure rate 166. In one or more examples, material temperature 132 is progressively or incrementally increased to predetermined degas temperature 138 at predetermined temperature rate 168.

In one or more examples, predetermined degas pressure 148 is approximately 90 psi (approximately 620 kPa). In one or more examples, predetermined degas pressure 148 progressively increases from approximately 75 psi (approximately 517 kPa) to approximately 90 psi (approximately 620 kPa) at predetermined pressure rate 166.

In one or more examples, predetermined degas temperature 138 is approximately 350 °F (approximately 176 °C). In one or more examples, predetermined degas temperature 138 progressively increases from approximately 275 °F (approximately 135 °C) to approximately 350 °F (approximately 176 °C) at predetermined temperature rate 168.

In one or more examples, predetermined degas period 164 is approximately 180 minutes.

In one or more examples, method 1000 includes, at 1032, a step of cooling polymer material 210 (e.g., cured polymer material 224). In one or more examples, the step of cooling represents an intermediate stage of the disclosed curing process during which the molecular structure of the polymer material is stabilized, residual stresses are relieved, and mechanical, thermal, and chemical properties are stabilized to ensure final properties are achieved.

According to method 1000, cooling is achieved by reducing exterior pressure 142 and/or material temperature 132. In one or more examples, method 1000 includes, at 1034, a step of decreasing exterior pressure 142 and, at 1036, decreasing material temperature 132 until cured polymer material 224 is cooled. In one or more examples, exterior pressure 142 is progressively or incrementally decreased to predetermined cooled pressure 147 at predetermined pressure rate 166. In one or more examples, material temperature 132 is progressively or incrementally decreased to predetermined cooled temperature 137 at predetermined temperature rate 168.

In one or more examples, predetermined cooled pressure 147 is about atmospheric pressure, such as approximately 15 psi (approximately 103 kPa). In one or more examples, predetermined cooled pressure 147 progressively decreases from approximately 90 psi (approximately 620 kPa) to about atmospheric pressure at predetermined pressure rate 166.

In one or more examples, predetermined cool temperature 137 is about room temperature, such as approximately 50 °F (approximately 10 °C). In one or more examples, predetermined cooled temperature 137 progressively decreases from approximately 350 °F (approximately 176 °C) to approximately 50 °F (approximately 10 °C) at predetermined temperature rate 168.

In one or more examples, method 1000 includes, at 1038, a step of post-curing polymer material 210 (e.g., cured polymer material 224). In one or more examples, the step of post-curing represents a subsequent stage of the disclosed curing process during which the molecular structure of the polymer material is stabilized, such as in which molecular crosslinking is completed, mechanical strength is improved, thermal stability is enhanced, residual stress is reduced, and/or remaining volatile components are eliminated.

According to method 1000, post-curing is achieved by setting exterior pressure 142, increasing material temperature 132, and maintaining exterior pressure 142 and material temperature 132 for a predetermined dwell time (e.g., the duration of the post-curing stage). In one or more examples, method 1000 includes, at 1040, a step of setting exterior pressure 142 to predetermined post-cure pressure 149 and, at 1042, increasing material temperature 132 to predetermined post-cure temperature 139. In one or more examples, method 1000 includes, at 1044, a step of, maintaining exterior pressure 142 at predetermined post-cure pressure 149 and maintaining material temperature 132 at predetermined post-cure temperature 139 for predetermined post-cure period 169. In one or more examples, material temperature 132 is progressively or incrementally increased to predetermined post-cure temperature 139 at predetermined temperature rate 168.

In one or more examples, predetermined post-cure pressure 149 is about atmospheric pressure, such as approximately 15 psi (approximately 103 kPa).

In one or more examples, predetermined post-cure temperature 139 is approximately 350 °F (approximately 176 °C). In one or more examples, predetermined post-cure temperature 139 progressively increases from approximately 50 °F (approximately 10 °C) to approximately 350 °F (approximately 176 °C) at predetermined temperature rate 168.

In one or more examples, predetermined post-cure period 169 is approximately 12 hours.

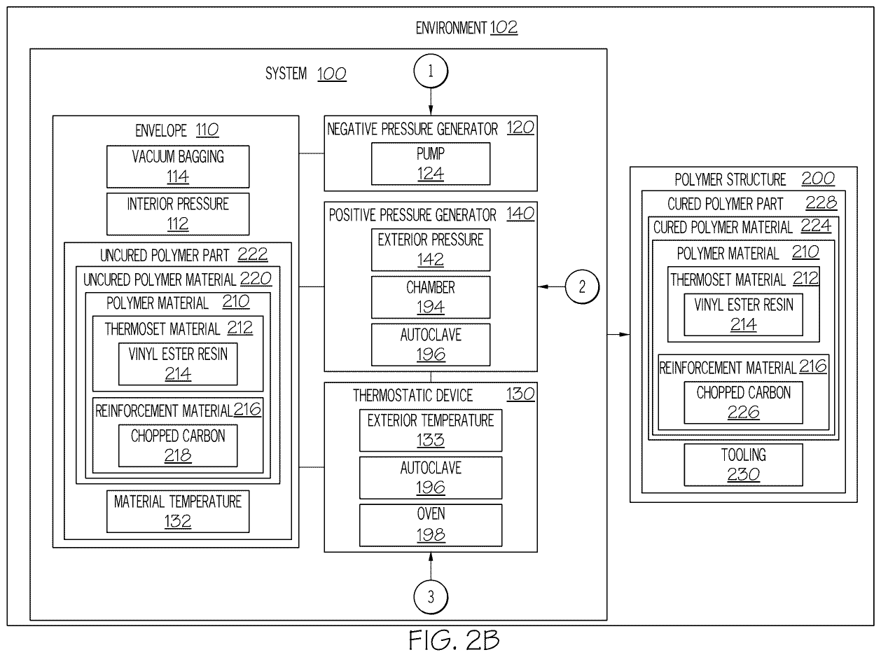

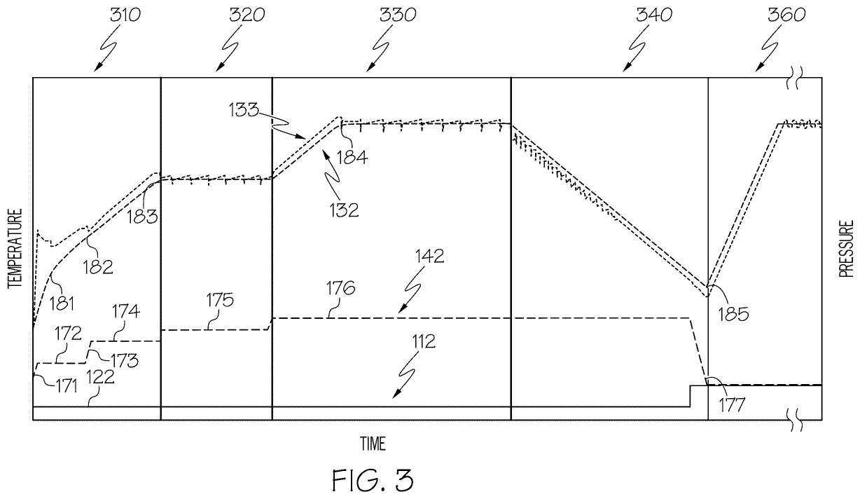

Referring now to FIGS. 3 and 4, which illustrate an example of the cure cycle according to method 1000. FIG. 3 graphically illustrates interior pressure 112, exterior pressure 142, material temperature 132, and exterior temperature 133 of an example of the cure cycle over time. As illustrated in FIG. 3, in one or more examples, the cure cycle, according to method 1000, includes five phases, namely, flow phase 310, cure phase 320, degas phase 330, cool phase 340, and post-cure phase 360. In other examples, the cure cycle, according to method 1000, can have a different number of phases, for example, one or more of the depicted phases can be combined into a single phase or separated into multiple phases. FIG. 4 illustrates a specific example of various predetermined parameters 152 of the cure cycle utilized by method 1000. As illustrated in FIG. 4, in one or more examples, the cure cycle, according to method 1000, includes ten stages, such as flow phase 310 including five stages, cure phase 320 including two stages, degas phase 330 including two stages, and cool phase 340 including one stage. In other examples, the cure cycle, according to method 1000, can have a different number of stages, for example, one or more of the depicted stages can be combined into a single stage or separated into multiple stages.

In the examples illustrated in FIGS. 3 and 4, flow phase 310 is an example or implementation of the step of applying negative pressure (e.g., at 1004 in FIG. 1) and the step of inducing flow (e.g., at 1010 in FIG. 1). Cure phase 320 is an example or implementation of the step of curing (e.g., at 1016 in FIG. 1). Degas phase 330 is an example or implementation of the step of degassing (e.g., at 1024 in FIG. 1). Cool phase 340 is an example or implementation of the step of cooling (e.g., at 1032 in FIG. 1). Post-cure phase 3560 is an example or implementation of the step of post-curing (e.g., at 1038 in FIG. 1).

As illustrated in FIGS. 3 and 4, in one or more examples, a first stage (SAG #1) of method 1000 (e.g., first stage of flow phase 310) includes a step of decreasing interior pressure 112 to predetermined negative pressure 122. As illustrated in FIG. 4, in one or more examples, predetermined negative pressure 122 is approximately −30 inHg (approximately −1015.9 hPa).

As illustrated in FIGS. 3 and 4, in one or more examples, a second stage (SAG #2) of method 1000 (e.g., second stage of flow phase 310) includes a step of increasing exterior pressure 142 to first predetermined pressure 171. In one or more examples, exterior pressure 142 is increased to first predetermined pressure 171 at predetermined pressure rate 166. According to method 1000, the second stage includes a step of increasing material temperature 132 to first predetermined temperature 181. In one or more examples, material temperature 132 is increased (e.g., progressively or incrementally) to first predetermined temperature 181 at predetermined temperature rate 168. As illustrated in FIG. 4, in one or more examples, first predetermined pressure 171 is between approximately 14 psi and 15 psi (e.g., between approximately 96 kPa and 103 kPa). In one or more examples, first predetermined temperature 181 is approximately 150 °F (approximately 65 °C).

As illustrated in FIGS. 3 and 4, in one or more examples, a third stage (SAG #3) of method 1000 (e.g., third stage of flow phase 310) begins at (e.g., upon achieving) first predetermined temperature 181. In one or more examples, the third stage includes a step of increasing exterior pressure 142 to second predetermined pressure 172. In one or more examples, exterior pressure 142 is increased to second predetermined pressure 172 at the predetermined pressure rate 166. In one or more examples, the third stage includes a step of increasing material temperature 132 to second predetermined temperature 182. In one or more examples, material temperature 132 is increased to second predetermined temperature 182 at predetermined temperature rate 168. As illustrated in FIG. 4, in one or more examples, second predetermined pressure 172 is approximately 30 psi (approximately 206 kPa). In one or more examples, second predetermined temperature 182 is between approximately 190 °F and 200 °F (between approximately 87 °C and 93 °C).

As illustrated in FIGS. 3 and 4, in one or more examples, a fourth stage (SAG #4) of method 1000 (e.g., fourth stage of flow phase 310) begins at (e.g., upon achieving) second predetermined temperature 182. In one or more examples, the fourth stage includes a step of increasing exterior pressure 142 to third predetermined pressure 173. In one or more examples, exterior pressure 142 in increased to third predetermined pressure 173 at predetermined pressure rate 166. In one or more examples, exterior pressure 142 in increased to third predetermined pressure 173 while maintaining material temperature 132 at second predetermined temperature 182. As illustrated in FIG. 4, in one or more examples, third predetermined pressure 173 is approximately 45 psi (approximately 310.3 kPa). In one or more examples, second predetermined temperature 182 is between approximately 190 °F and 200 °F (between approximately 87 °C and 93 °C).

As illustrated in FIGS. 3 and 4, in one or more examples, a fifth stage (SAG #5) of method 1000 (e.g., fifth stage of flow phase 310) begins at (e.g., upon achieving) third predetermined pressure 173. In one or more examples, the fifth stage includes a step of increasing exterior pressure 142 to fourth predetermined pressure 174 and a step of increasing material temperature 132 to third predetermined temperature 183. In one or more examples, exterior pressure 142 is increased to fourth predetermined pressure 174 at predetermined pressure rate 166. In one or more examples, material temperature 132 is increased to third predetermined temperature 183 at predetermined temperature rate 168. In one or more examples, increasing exterior pressure 142 and increasing material temperature 132 occur concurrently. In one or more examples, exterior pressure 142 is maintained at fourth predetermined pressure 174 until material temperature 132 reaches third predetermined temperature 183. As illustrated in FIG. 4, in one or more examples, fourth predetermined pressure 174 is approximately 60 psi (approximately 413 kPa). In one or more examples, third predetermined temperature 183 is between approximately 270 °F and 275 °F (between approximately 132 °C to 135 °C).

As illustrated in FIGS. 3 and 4, in one or more examples, a sixth stage (SAG #6) of method 1000 (e.g., first stage of cure phase 320) begins at (e.g., upon achieving) fourth predetermined pressure 174 and third predetermined temperature 183. In one or more examples, the sixth stage includes a step of increasing exterior pressure 142 to fifth predetermined pressure 175. In one or more examples, exterior pressure 142 is increased to fifth predetermined pressure 175 at predetermined pressure rate 166. In one or more examples, exterior pressure 142 is increased to fifth predetermined pressure 175 while maintaining material temperature 132 at third predetermined temperature 183. As illustrated in FIG. 4, in one or more examples, fifth predetermined pressure 175 is approximately 75 psi (approximately 517 kPa). In one or more examples, third predetermined temperature 183 is between approximately 270 °F and 275 °F (between approximately 132 °C to 135 °C).

As illustrated in FIGS. 3 and 4, in one or more examples, a seventh stage (SAG #7) of method 1000 (e.g., second stage of cure phase 320) begins at (e.g., upon achieving) at fifth predetermined pressure 175. In one or more examples, the seventh stage includes a step of maintaining exterior pressure 142 at fifth predetermined pressure 175. In one or more examples, the seventh stage includes a step of maintaining material temperature 132 at third predetermined temperature 183. In one or more examples, exterior pressure 142 is maintained at fifth predetermined pressure 175 and material temperature 132 is maintained at third predetermined temperature 183 for predetermined cure period 162. As illustrated in FIG. 4, in one or more examples, predetermined cure period 162 is divided into two segments between the sixth stage and the seventh stage of method 1000 (e.g., first and second stages of cure phase 320), for example, in which each stage or segment is approximately 60 minutes.

As illustrated in FIGS. 3 and 4, in one or more examples, an eighth stage (SAG #8) of method 1000 (e.g., first stage of degas phase 330) begins after predetermined cure period 162. In one or more examples, the eighth stage includes a step of increasing exterior pressure 142 to sixth predetermined pressure 176. In one or more examples, exterior pressure 142 is increased to sixth predetermined pressure 176 at predetermined pressure rate 166. The eighth stage includes a step of increasing material temperature 132 to fourth predetermined temperature 184. In one or more examples, material temperature 132 is increased to fourth predetermined temperature 184 at predetermined temperature rate 168. As illustrated in FIG. 4, in one or more examples, sixth predetermined pressure 176 is approximately 90 psi (approximately 620 kPa). In one or more examples, fourth predetermined temperature 184 is between approximately 345 °F and 350 °F (between approximately 173 °C and 176 °C).

As illustrated in FIGS. 3 and 4, in one or more examples, a ninth stage (SAG #9) of method 1000 (e.g., second stage of degas phase 330) begins at (e.g., upon achieving) sixth predetermined pressure 176 and fourth predetermined temperature 184. In one or more examples, the ninth stage includes a step of maintaining exterior pressure 142 at sixth predetermined pressure 176 and a step of maintaining material temperature 132 at fourth predetermined temperature 184 for predetermined degas period 164.

As illustrated in FIGS. 3 and 4, in one or more examples, a tenth stage (SAG #10) of method 1000 (e.g., first stage of cool phase 340) begins after predetermined degas period 164. In one or more examples, the tenth stage includes a step of decreasing exterior pressure 142 to seventh predetermined pressure 177. In one or more examples, exterior pressure 142 is decreased to seventh predetermined pressure 177 at predetermined pressure rate 166. In one or more examples, the tenth stage includes a step of decreasing material temperature 132 to fifth predetermined temperature 185. In one or more examples, material temperature 132 is decreased to fifth predetermined temperature 185 at the predetermined temperature rate 168. As illustrated in FIG. 4, in one or more examples, seventh predetermined pressure 177 is approximately atmospheric pressure (approximately 14.7 psi or 101 kPa). In one or more examples, fifth predetermined temperature 185 is less than approximately 150 °F (approximately 65 °C). In one or more examples, fifth predetermined temperature 185 is between approximately 50 °F and 150 °F (between approximately 10 °C to 65 °C). In one or more examples, fifth predetermined temperature 185 is ambient or room temperature.

While not explicitly illustrated in FIGS. 3 and 4, in one or more examples, following the cure cycle (e.g., after cool phase 340), polymer material 210 (e.g., cured polymer material 224) is, optionally, subjected to a post-cure phase. The post-cure phase is an example or implementation of the step of post-curing (e.g., at 1038 in FIG. 1). In one or more examples, the post-cure phase includes a step of maintaining the exterior pressure 142 at the seventh predetermined pressure 177 and a step of removing the polymer material 210 (e.g., cured polymer material 224) from envelope 110. In one or more examples, the post-cure phase also includes a step of increasing material temperature 132 to a sixth predetermined temperature. In one or more examples, the sixth predetermined temperature approximately 350 °F (approximately 176 °C). In one or more examples, the post-cure phase includes maintaining material temperature 132 at the sixth predetermined temperature for predetermined post-cure period 169.

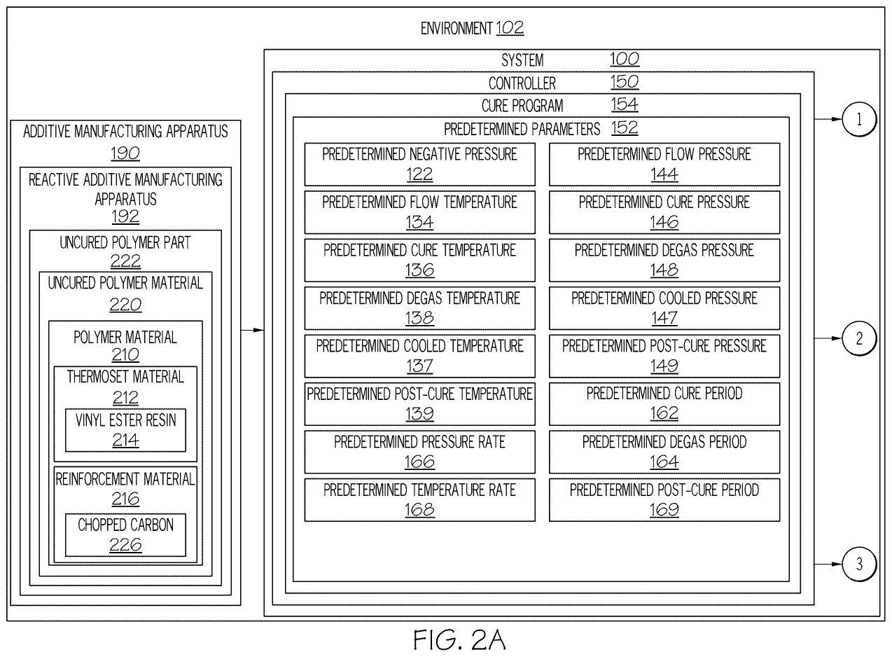

Referring now to FIGS. 2A and 2B, which may also be referred to collectively herein as FIG. 2, by way of examples, the present disclosure is directed to system 100 for curing polymer material 210. The following are examples of system 100, according to the present disclosure. In one or more examples, method 1000 (FIG. 1) is implemented using system 100. Examples of system 100 include a number of elements, features, and components or combinations thereof. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

As illustrated in FIGS. 2A and 2B, in one or more examples, system 100 operates in manufacturing environment 102 and includes envelope 110, negative pressure generator 120, thermostatic device 130, positive pressure generator 140, and controller 150. Envelope 110 is configured to receive polymer material 210 (e.g., uncured polymer material 220, such as uncured polymer part 222). Negative pressure generator 120 is configured to control, adjust, influence, regulate, modulate, and/or maintain interior pressure 112 within envelope 110. Thermostatic device 130 is configured to control, adjust, influence, regulate, modulate, and/or maintain material temperature 132 of polymer material 210. Positive pressure generator 140 is configured to control, adjust, influence, regulate, modulate, and/or maintain exterior pressure 142 surrounding envelope 110. Controller 150 is programmed or adapted to control, adjust, influence, regulate, modulate, and/or otherwise instruct negative pressure generator 120, thermostatic device 130, and positive pressure generator 140.

In one or more examples, controller 150 is adapted to cause negative pressure generator 120 to reduce interior pressure 112 to predetermined negative pressure 122. In one or more examples, controller 150 is adapted to cause positive pressure generator 140 to increase exterior pressure 142 to predetermined flow pressure 144 and to cause thermostatic device 130 to increase material temperature 132 to predetermined flow temperature 134 to induce flow in polymer material 210 (e.g., flow phase 310). In one or more examples, controller 150 is adapted to cause positive pressure generator 140 to increase exterior pressure 142 to predetermined cure pressure 146 and to cause thermostatic device 130 to increase material temperature 132 to predetermined cure temperature 136 and to cause thermostatic device 130 and positive pressure generator 140 to maintain predetermined cure pressure 146 and predetermined cure temperature 136 for predetermined cure period 162 to cure polymer material 210 (e.g., cure phase 320). In one or more examples, controller 150 is adapted to cause positive pressure generator 140 to increase exterior pressure 142 to predetermined degas pressure 148 and to cause thermostatic device 130 to increase material temperature 132 to predetermined degas temperature 138 and to cause positive pressure generator 140 and thermostatic device 130 to maintain predetermined degas pressure 148 and predetermined degas temperature 138 for predetermined degas period 164 to degas polymer material 210 (e.g., degas phase 330). In one or more examples, controller 150 is adapted to cause positive pressure generator 140 to reduce or decrease exterior pressure 142 and to cause thermostatic device 130 to reduce or decrease material temperature 132 to cool polymer material 210 (e.g., cool phase 340).

Negative pressure generator 120 can include or take the form of any suitable device or mechanism capable of generating, causing, creating, regulating, modulating, and/or maintaining a low-pressure environment (e.g., below atmospheric pressure), such as by removing air or gases from a sealed space. In one or more examples, negative pressure generator 120 includes or takes the form of a pump (e.g., pump 124) or suction mechanism that removes air and gases from envelope 110, creating a pressure differential where exterior pressure 142 is higher than interior pressure 112. In combination, negative pressure generator 120 and envelope 110 serve to remove void, compact layers, and/or controls flow of polymer material 210.

Thermostatic device 130 can include or take the form of temperature control device, thermal regulation device, or other suitable device or mechanism capable of influencing, adjusting, modulating, managing, regulating, and/or maintaining a specified temperature of a defined environment. In these examples, thermostatic device 130 regulates and maintains material temperature 132 and/or exterior temperature 133. In one or more examples, thermostatic device 130 regulates material temperature 132 by controlling exterior temperature 133. In one or more examples, thermostatic device 130 includes or takes the form of a heating element and/or cooling element.

Positive pressure generator 140 can include or take the form of any suitable device or mechanism capable of generating, causing, creating, regulating, modulating, and/or maintaining a high-pressure environment (e.g., above atmospheric pressure) within a sealed space. In one or more examples, positive pressure generator 140 regulates and maintains exterior pressure 142. In one or more examples, positive pressure generator 140 includes or takes the form of a pump, compressor, or other pressure source or mechanism capable of pressurizing fluid (e.g., gases).

In one or more examples, thermostatic device 130 includes or takes the form oven 198. In one or more examples, positive pressure generator 140 includes or takes the form of chamber 194 with a pressure source (e.g., pump, compressor, etc.) that increases the pressure within chamber 194 when sealed. In one or more examples, thermostatic device 130 and positive pressure generator 140 are integrated to include or take the form of autoclave 196. In these examples, thermostatic device 130 and positive pressure generator 140, each or in combination, include associated control systems (e.g., controller 150), safety features, sensors, feedback systems, and the like.

Referring again to FIG. 2, by way of examples, the present disclosure is directed to polymer structure 200. The following are examples of polymer structure 200, according to the present disclosure. In one or more examples, polymer structure 200 is formed, made, manufactured, fabricated, or produced according to method 1000 (FIG. 1) or using system 100 (FIG. 2). Examples of polymer structure 200 include a number of elements, features, and components or combinations thereof. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

In one or more examples, polymer structure 200 includes polymer material 210, which is cured by: (1) sealing polymer material 210 (e.g., uncured polymer part 222) within envelope 110; (2) reducing interior pressure 112 within envelope 110 to predetermined negative pressure 122; (3) inducing flow of polymer material 210 by increasing exterior pressure 142 to predetermined flow pressure 144 and material temperature 132 to predetermined flow temperature 134; (4) curing polymer material 210 by increasing exterior pressure 142 to predetermined cure pressure 146 and material temperature 132 to predetermined cure temperature 136 and maintaining for predetermined cure period 162; (5) degassing polymer material 210 by increasing exterior pressure 142 to predetermined degas pressure 148 and material temperature to predetermined degas temperature 138 and maintaining for predetermined degas period 164; and (6) cooling polymer material 210 (e.g., cured polymer material 224).

In one or more examples, polymer structure 200 takes the form of tooling 230. In one or more examples, polymer structure 200 (e.g., tooling 230) is made from vinyl ester resin 214 filled with chopped carbon 226 using a RAM technique and is cured according to method 1000. In one or more examples, tooling 230 is a cure tool (e.g., mold, mandrel, etc.) used for curing various types of polymer materials, composite materials, or other materials. In these examples, tooling 230, made from polymer material 210 and cured according to method 1000, can be utilized as autoclave tooling and has physical properties capable of withstanding autoclave temperatures (e.g., temperatures ranging from approximately 250 °F (approximately 121 °C) to approximately 375 °F (approximately 190 °C)) and autoclave pressures (e.g., greater than approximately 10 psi (approximately 68 kPa)) through multiple cycles. As cured according to method 1000, polymer structure 200 (e.g., tooling 230) has a low to zero porosity and a low thermal expansion, is capable of withstanding elevated temperatures without thermal degradation, and maintains a surface profile within a predetermined tolerance.

In one or more examples, polymer material 210 is a multicomponent reactive thermoset, such as a cobalt accelerated, cold curing, non-Newtonian fluid. In this example, polymer material 210 naturally resists pressure. Examples of polymer material 210 include Polynt PRD-1586 and Polynt PRD-1647, which, at the time of the present disclosure, are commercially available from Polynt Composites USA Inc. of Illinois, USA.

In one or more examples, according to method 1000, pressure and vacuum are applied to polymer material 210 within vacuum bagging 114 to facilitate removal of air pockets and volatile organic compounds (VOCs) created or otherwise stemming from the chemical reactions of the multicomponent reactive thermoset. Polymer material 210 is cured in autoclave 196, which is programmed to controllably increase pressure to avoid excessive exothermic reaction temperatures due to the applied pressure. The controlled rise of pressure facilitates a desired mixing and crosslinking of layers of polymer material 210. Predetermined negative pressure 122 is applied throughout the entire cure cycle to pull our gasses created by the chemical reactions. The temperature of polymer material 210 is raised to approximately 250 °F (approximately 121 °C) to facilitate crosslinking and is then raised to above approximately 300 °F (approximately 148 °C) to facilitate escape of volatiles. Polymer material 210 is then removed from vacuum bagging 114 and subjected to a post-cure phase at a temperature of approximately 350 °F (approximately 176 °C) to facilitate escape of any remaining or trapped volatiles and evaporation of any condensate on the surface of polymer material 210 (e.g., cured polymer material 224). Accordingly, examples of method 1000 provide a cure cycle that matches the exothermic reaction ramp rate of polymer material 210 due to applying pressure and heat to the vinyl ester resin with carbon designed for cold cure. The controlled steps of adding pressure and maintaining for predetermined dwell times facilitate removing VOCs and material flow. The increased temperature dwell time, while under pressure and vacuum facilitate escape of volatiles without causing an undesired porosity.

In one or more examples, vacuum bagging 114 contains, encloses, surrounds, seals, or encompasses polymer material 210 (e.g., 3D printed multicomponent reactive thermoset material) during the cure process. In one or more examples, vacuum bagging 114 is an envelope-style bag without bridging in any of the radii to prevent polymer material 210 from warping before crosslinking completes. In one or more examples, thermocouples or other sensors are installed in polymer material 210 and autoclave 196 monitors material temperature 132 and adjusts itself accordingly based on cure program 154. The autoclave sensors monitor the temperature ramp rate of polymer material 210 as pressure and heat are applied. Cure program 154 instructs autoclave 196 to adjust the pressure and heat applied to keep polymer material 210 from curing too fast. This controlled process results in improved resin flow and facilities the pull-out of trapped air while polymer material 210 is at a gel temperature.

The present disclosure recognizes that method 1000 and system 100 provide unique advantages and benefits for curing multicomponent reactive thermoset materials formed (e.g., three-dimensionally printed) by RAM techniques and systems. In such examples, when the catalyst and epoxy resin of polymer material 210 interact, there is an exothermic reaction. This reaction hardens polymer material 210 so that when additively manufactured (e.g., built-up, deposited, layered, or printed), it is stable enough to be built up along the Z-axis. However, the present disclosure recognizes that, if not controlled correctly, a runaway reaction or thermal runaway can occur. If this occurs, polymer material 210 can burn itself up and turn into an unusable material. The reaction also produces a gas that can get trapped inside polymer material 210 leaving air pockets or porosity. However, the printing process has no control over the reaction. In response, method 1000 (e.g., cure program 154 of autoclave 196) is adapted to prevent a runaway reaction. Additionally, because polymer material 210 is a non-Newtonian fluid, which resists pressure naturally, method 1000 (e.g., cure program 154 of autoclave 196) is adapted to improve mixing and crosslinking of the material layers formed from the printing process for increased strength and reduced porosity compared to conventional processes. Further, method 1000 (e.g., cure program 154 of autoclave 196) is adapted to allow the gas produced by the chemical reaction to escape without producing voids in polymer material 210.

In one or more examples, method 1000 (e.g., cure program 154 of autoclave 196) achieves these advantages and benefits by implementing a controlled build-up of pressure with predetermined maximum and minimum temperature limits during curing. The controlled increase of pressure prevents the runaway reaction and allows the pressure resistant material to “flow.” The flow is important because that is what allows the printed layers to combine while allowing air pockets to escape due to vacuum bagging 114 and predetermined negative pressure 122. The predetermined maximum and minimum temperature settings instruct autoclave 196 to heat polymer material 210 if material temperature 132 approaches the predetermined minimum temperature setting and instructs autoclave 196 to cool polymer material 210 if material temperature 132 approaches predetermined maximum temperature setting. As such, the predetermined maximum and minimum temperature settings beneficially prevent a runaway reaction while ensuring polymer material 210 reaches an appropriate temperature that allows the material to flow and then reaches cure temperature.

Referring again to FIG. 3, which illustrates a general example of method 1000 and implementation of cure program 154. Flow phase 310 relies on heat and pressure to avoid thermal runaway. The predetermined temperatures allow the resin to flow. The progressive or staged increases in pressure and/or temperature are selected at a rate sufficient to allow gas to escape before polymer material 210 reaches the cure temperature. The pressure is set to controllably increase at a predetermine rate because, in some examples, polymer material 210 resists pressure. In these examples, excessive pressure can inhibit the flow of polymer material 210. Alternatively, insufficient pressure or uncontrolled flow can increase thermal reactivity to the point of failure. In one or more examples, vacuum is maintained throughout the cycle because the chemical reaction produces gas. During cure phase 320, the cure temperatures are maintained while the pressure is increased to push out volatiles while polymer material 210 is curing. Degas phase 330 brings any leftover volatiles remaining inside polymer material 210 to a boiling point while inside vacuum bagging 114. This allows the volatiles to escape to the surface through any microporosity in polymer material 210. In some cases, the volatiles can leave a sticky brown residue on cured polymer material 224 (e.g., cured polymer part 228) that is later removed (e.g., cooked off) during the post-cure phase. Cool phase 340 serves as a controlled cool down of polymer material 210 and helps to avoid cracking thereof.

Referring again to FIG. 4, which illustrates a specific example of method 1000 and implementation of cure program 154. In this example, predetermined parameters 152 and cure cycle limits are set (e.g., provided to cure program 154). In this example, temperatures rate limits are set to not increase more than approximately 1 °F per minute (approximately 0.56 °C per minute) to avoid thermal runaway and not to decrease more than approximately 1 °F per minute to keep polymer material 210 from cooling too fast and possibly cracking. The first stage (e.g., SAG #1) represents the starting point of the cure process in which predetermined negative pressure 122 is applied to polymer material 210 within vacuum bagging 114. The second stage (SAG #2) represents instructions to autoclave 196 to raise exterior pressure 142 above 14 psi. The temperature value instructs autoclave 196 to not allow polymer material 210 to exceed approximately 150 °F. The third stage (SAG #3) represents instructions to autoclave 196 to raise exterior temperature 133 within autoclave 196 until material temperature 132 is above 190 °F but below 200 °F while reaching exterior pressure 142 of 30 psi. The fourth stage (SAG #4) represents instructions to autoclave 196 to maintain material temperature 132 until exterior pressure 142 reaches 45 psi. The fifth stage (SAG #5) represents instructions to autoclave 196 to raise exterior temperature 133 within autoclave 196 until material temperature 132 is above 270 °F but below 275 °F while reaching exterior pressure 142 of 60 psi. The sixth stage (SAG #6) represents instruction to autoclave 196 to start a 60-minute timer when material temperature 132 is above 270 °F but below 275 °F and exterior pressure 142 reaches 75 psi. The seventh stage (SAG #7) represents instruction to autoclave 196 to keep the settings of the sixth stage for another 60 minutes. The eighth stage (SAG #8) represents instruction to autoclave 196 to raise exterior temperature 133 within autoclave 196 until material temperature 132 is above 345 °F but below 350 °F while reaching exterior pressure 142 of 90 psi. The ninth stage (SAG #9) represents instruction to autoclave 196 to start a 180-minute timer when the conditions of the eighth stage are met. The tenth stage (SAG #10) represents instruction to autoclave 196 to reduce heat until material temperature 132 is below 150 °F.

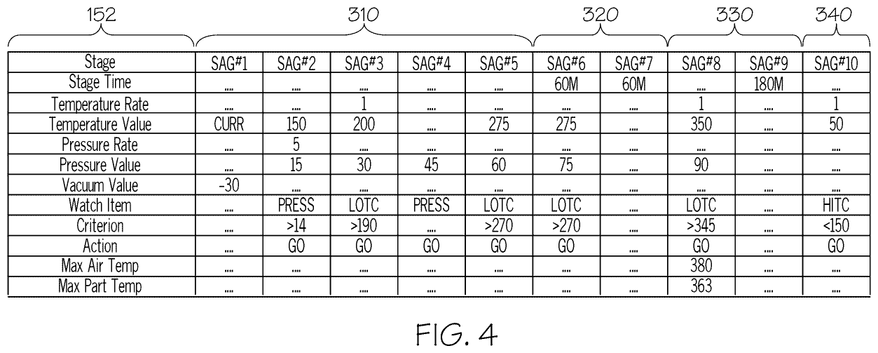

FIG. 5 illustrates an example of data processing system 900. In one or more examples, the controller 150 (FIG. 2) includes or takes the form of data processing system 900. In one or more examples, the data processing system 900 includes a communications framework 902, which provides communications between at least one processor 904, one or more storage devices 916, such as memory 906 and/or persistent storage 908, communications unit 910, input/output unit 912 (I/O unit), and display 914. In this example, communications framework 902 takes the form of a bus system. Processor 904 serves to execute instructions from software or other applications that can be loaded into memory 906. In one or more examples, processor 904 is a number of processor units, a multi-processor core, or some other type of processor, depending on the particular implementation. Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in one or more examples. Memory 906 is, for example, a random-access memory or any other suitable volatile or non-volatile storage device. Persistent storage 908 can take various forms, depending on the particular implementation. For example, persistent storage 908 contains one or more components or devices. For example, persistent storage 908 is a hard drive, a solid-state hard drive, a flash memory, a rewritable optical disk, a rewritable magnetic tape, or some combination of the above. The media used by persistent storage 908 also can be removable. For example, a removable hard drive can be used for persistent storage 908.

Communications unit 910 provides for communications with other systems or devices, such as negative pressure generator 120 thermostatic device 130, positive pressure generator 140, or other computer systems. In one or more examples, communications unit 910 is a network interface card. Input/output unit 912 allows for input and output of data with other devices that can be connected to data processing system 900. As an example, input/output unit 912 provides a connection for user input through at least one of a keyboard, a mouse, or some other suitable input device. Further, input/output unit 912 can send output to a printer. Display 914 provides a mechanism to display information to a user.

Instructions (e.g., cure program 154) for at least one of the operating system, applications, or programs can be located in storage devices 916, which are in communication with processor 904 through communications framework 902. Control or instruction of the processes of the various examples and operations described herein can be performed by processor 904 using computer-implemented instructions, which can be located in a memory, such as memory 906. The instructions can be referred to as program code, computer usable program code, or computer readable program code that can be read and executed by a processor of processor 904. The program code in the different examples can be embodied on different physical or computer readable storage media, such as memory 906 or persistent storage 908.

In one or more examples, cure program 154 includes or takes the form of program code 918. Program code 918 is located in a functional form on computer-readable media 920 that is selectively removable and can be loaded onto or transferred to the data processing system 900 for execution by the processor 904. In one or more examples, the program code 918 and computer readable media 920 form the computer program product 922. In one or more examples, computer-readable media 920 is computer-readable storage media 924. In one or more examples, computer-readable storage media 924 is a physical or tangible storage device used to store program code 918 rather than a medium that propagates or transmits the program code 918. Alternatively, program code 918 can be transferred to data processing system 900 using a computer-readable signal media. The computer-readable signal media can be, for example, a propagated data signal containing program code 918. For example, computer-readable signal media can be at least one of an electromagnetic signal, an optical signal, or any other suitable type of signal. These signals can be transmitted over at least one of communications links, such as wireless communications links, optical fiber cable, coaxial cable, a wire, or any other suitable type of communications link.

The different components illustrated for data processing system 900 are not meant to provide architectural limitations in the manner in which different examples can be implemented. The different examples can be implemented in a data processing system including components in addition to or in place of those illustrated for data processing system 900. Other components shown in FIG. 5 can be varied from the examples shown. The different examples can be implemented using any hardware device or system capable of running program code 918.

Additionally, various components of controller 150, data processing system 900, and/or program code 918 (e.g., cure program 154) may be described as modules or applications. For the purpose of the present disclosure, the term “module” includes hardware, software or a combination of hardware and software. As an example, a module can include one or more circuits configured to perform or execute the described functions or operations of the executed processes described herein (e.g., the method 1000). As another example, a module includes a processor, a storage device (e.g., a memory), and computer-readable storage medium having instructions that, when executed by the processor causes the processor to perform or execute the described functions and operations. In one or more examples, a module takes the form of program code 918 and the computer-readable media 920 together forming computer program product 922.

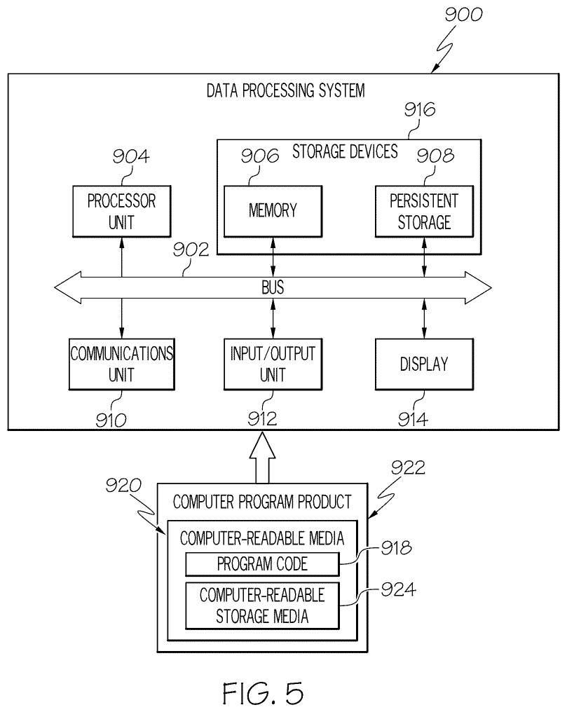

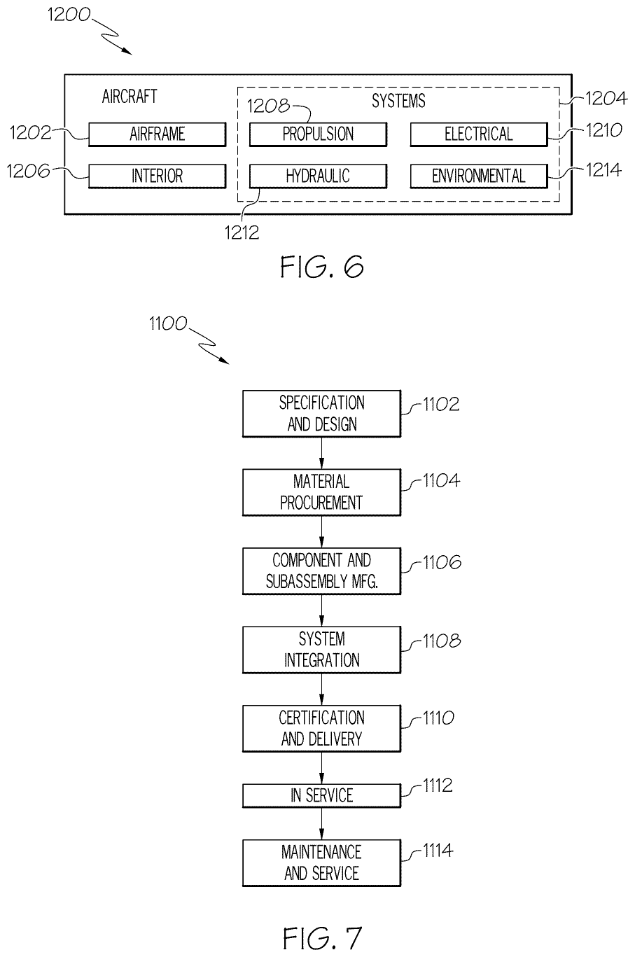

Referring now to FIGS. 6 and 7 examples of system 100, method 1000, and polymer structure 200, described herein, may be related to, or used in the context of, aircraft 1200, as schematically illustrated in FIG. 6, and aerospace manufacturing and service method 1100, as shown in the flow diagram of FIG. 7. As an example, aircraft 1200 and/or manufacturing and service method 1100 may utilize polymer components (e.g., polymer structure 200) that have been cured using system 100 and/or according to method 1000. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may apply to the use of various products in the manufacture of various types of vehicles, such as land, sea, rail, and space-based vehicles, in the construction of various types of buildings, and/or in the manufacture of various types of industrial and/or consumer products.

Referring to FIG. 6, which illustrates an example of aircraft 1200. Aircraft 1200 can be any aerospace vehicle or platform, such as, but not limited to, a fixed wing aircraft, a rotorcraft, a vertical takeoff and landing (VTOL) aircraft, an unmanned aerial vehicle (UAV) or drone, commercial, passenger, or military aircraft, and the like. In one or more examples, aircraft 1200 includes airframe 1202 having interior 1206. Aircraft 1200 includes a plurality of onboard systems 1204 (e.g., high-level systems). Examples of onboard systems 1204 of aircraft 1200 include propulsion systems 1208, hydraulic systems 1212, electrical systems 1210, and environmental systems 1214. In other examples, onboard systems 1204 also includes one or more control systems coupled to airframe 1202 of aircraft 1200. In yet other examples, onboard systems 1204 also include one or more other systems, such as, but not limited to, communications systems, avionics systems, software distribution systems, network communications systems, passenger information/entertainment systems, guidance systems, radar systems, weapons systems, and the like. Aircraft 1200 can include a number of components made of polymer material 210 (e.g., polymer structure 200), which are cured using system 100 and/or according to method 1000, or other components fabricated on polymer molds (e.g., tooling 230) cured using the system 100 and/or according to method 1000.

Referring to FIG. 7, during pre-production of aircraft 1200, at 1102, the manufacturing and service method 1100 includes specification and design of aircraft 1200 and, at 1104, material procurement. During production of aircraft 1200, at 1106, component and subassembly manufacturing of aircraft takes place and, at 1108, system integration of aircraft 1200 takes place. Thereafter, at 1110, aircraft 1200 goes through certification and delivery and, at 1112, is placed in service. At 1114, routine maintenance and service of aircraft 1200 includes modification, reconfiguration, refurbishment, etc. of one or more systems of aircraft 1200.

Each of the processes of manufacturing and service method 1100 illustrated in FIG. 7 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of method 1000, system 100, and polymer structure 200, shown and described herein, may be employed during any one or more of the stages of manufacturing and service method 1100 shown in the flow diagram illustrated by FIG. 7. In an example, polymer components (e.g., cured polymer part 228) of aircraft 1200 can be cured using the system 100 and/or according to method 1000 or components of aircraft 1200 can be fabricated on polymer molds (e.g., tooling 230) cured using the system 100 and/or according to method 1000 during a portion of component and subassembly manufacturing (1106) and/or system integration (1108). Further, polymer components of aircraft 1200 can be cured using the system 100 and/or according to method 1000 or components of aircraft 1200 can be fabricated on polymer molds cured using the system 100 and/or according to method 1000 while aircraft 1200 is in service (1112). Also, polymer components of aircraft 1200 can be cured using the system 100 and/or according to method 1000 or components of aircraft 1200 can be fabricated on polymer molds cured using the system 100 and/or according to method 1000 during system integration (1108) and certification and delivery (1110). Similarly, polymer components of aircraft 1200 can be cured using the system 100 and/or according to method 1000 or components of aircraft 1200 can be fabricated on polymer molds cured using the system 100 and/or according to method 1000 while aircraft 1200 is in service (1112) and during maintenance and service (1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIG. 2-6, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIG. 2-6, referred to above, need to be included in every example and not all elements, features, and/or components described herein are necessarily depicted in each illustrative example. Accordingly, some of the elements, features, and/or components described and illustrated in FIG. 2-6 may be combined in various ways without the need to include other features described and illustrated in FIG. 2-6, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIG. 2-6, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIG. 2-6, and such elements, features, and/or components may not be discussed in detail herein with reference to each of FIG. 2-6. Similarly, all elements, features, and/or components may not be labeled in each of FIG. 2-6, but reference numerals associated therewith may be utilized herein for consistency.

In FIGS. 1 and 7, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 1 and 7 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need to be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of system 100, method 1000, and polymer structure 200 have been shown and described, modifications may occur to those skilled in the art upon reading the specification. The present application includes such modifications and is limited only by the scope of the claims.

What is claimed is:

1. A method for curing a polymer material, the method comprising:
sealing the polymer material within an envelope;
reducing an interior pressure within the envelope to a predetermined negative pressure;
inducing flow of the polymer material by increasing an exterior pressure to a predetermined flow pressure and a material temperature to a predetermined flow temperature;
curing the polymer material by increasing the exterior pressure to a predetermined cure pressure and the material temperature to a predetermined cure temperature and maintaining for a predetermined cure period;
degassing the polymer material by increasing the exterior pressure to a predetermined degas pressure and the material temperature to a predetermined degas temperature and maintaining for a predetermined degas period; and
cooling the polymer material.

2. The method of claim 1, wherein:
inducing flow of the polymer material further comprises:
increasing the exterior pressure at a predetermined pressure rate to a first predetermined pressure and increasing the material temperature at a predetermined temperature rate to a first predetermined temperature;
at the first predetermined temperature, increasing the exterior pressure at the predetermined pressure rate to a second predetermined pressure and increasing the material temperature to a second predetermined temperature;
at the second predetermined temperature, increasing the exterior pressure at the predetermined pressure rate to a third predetermined pressure while maintaining the material temperature at the second predetermined temperature; and
at the third predetermined pressure, increasing the exterior pressure at the predetermined pressure rate to a fourth predetermined pressure and increasing the material temperature at the predetermined temperature rate to a third predetermined temperature;
curing the polymer material further comprises:
at the fourth predetermined pressure, increasing the exterior pressure at the predetermined pressure rate to a fifth predetermined pressure while maintaining the material temperature at the third predetermined temperature;
at the fifth predetermined pressure, maintaining the exterior pressure at the fifth predetermined pressure and the material temperature at the third predetermined temperature for the predetermined cure period;
degassing the polymer material further comprises:
after the predetermined cure period, increasing the exterior pressure at the predetermined pressure rate to a sixth predetermined pressure and increasing the material temperature at the predetermined temperature rate to a fourth predetermined temperature; and
at the sixth predetermined pressure and the fourth predetermined temperature, maintaining the exterior pressure at the sixth predetermined pressure and the material temperature at the fourth predetermined temperature for the predetermined degas period; and
cooling the polymer material comprises:
after the predetermined degas period, decreasing the exterior pressure at the predetermined pressure rate to a seventh predetermined pressure and decreasing the material temperature at the predetermined temperature rate to a fifth predetermined temperature.

3. The method of claim 2, wherein the envelope comprises vacuum bagging.

4. The method of claim 2, further comprising maintaining the predetermined negative pressure within the envelope until cooling the polymer material.

5. The method of claim 2, further comprising forming an uncured polymer part comprising the polymer material by a reactive additive manufacturing process.

6. The method of claim 2, wherein:
the predetermined pressure rate is approximately 5 psi per minute; and
the predetermined temperature rate is approximately 1 °F per minute.

7. The method of claim 2, wherein:
the first predetermined pressure is between approximately 14 psi and 15 psi; and
the first predetermined temperature is approximately 150 °F.

8. The method of claim 2, wherein:
the second predetermined pressure is approximately 30 psi; and
the second predetermined temperature is between approximately 190 °F and 200 °F.

9. The method of claim 2, wherein:
the third predetermined pressure is approximately 45 psi; and
the second predetermined temperature is between approximately 190 °F and 200 °F.

10. The method of claim 2, wherein:
the fourth predetermined pressure is approximately 60 psi; and
the third predetermined temperature is between approximately 270 °F and 275 °F.

11. The method of claim 2, wherein:
the fifth predetermined pressure is approximately 75 psi; and
the third predetermined temperature is between approximately 270 °F and 275 °F.

12. The method of claim 2, wherein:
the sixth predetermined pressure is approximately 90 psi; and
the fourth predetermined temperature is between approximately 345 °F and 350 °F.

13. The method of claim 2, wherein:
the seventh predetermined pressure is approximately atmospheric pressure [14.7 psi]; and
the fifth predetermined temperature is between approximately 50 °F and 150 °F.

14. The method of claim 2, wherein the predetermined cure period is approximately 120 minutes.

15. The method of claim 2, wherein the predetermined degas period is approximately 180 minutes.

16. The method of claim 2, further comprising:
maintaining the exterior pressure at the seventh predetermined pressure;
removing the polymer material from the envelope; and
increasing the material temperature to a sixth predetermined temperature.

17. The method of claim 2, wherein the polymer material comprises vinyl ester resin.

18. The method of claim 16, wherein the polymer material further comprises chopped carbon.

19. A system comprising:
an envelope configured to receive a polymer material;
a negative pressure generator configured to control an interior pressure within the envelope;
a thermostatic device configured to control a material temperature of the polymer material;
a positive pressure generator configured to control an exterior pressure surrounding the envelope; and
a controller programmed to control the negative pressure generator, the thermostatic device, and the positive pressure generator and cause to:
reduce the interior pressure to a predetermined negative pressure;
increase the exterior pressure to a predetermined flow pressure and the material temperature to a predetermined flow temperature to induce flow in the polymer material;
increase the exterior pressure to a predetermined cure pressure and the material temperature to a predetermined cure temperature and maintain for a predetermined cure period to cure the polymer material;
increase the exterior pressure to a predetermined degas pressure and the material temperature to a predetermined degas temperature and maintain for a predetermined degas period to degas the polymer material; and
reduce the exterior pressure and the material temperature to cool the polymer material.

20. A polymer structure comprising a polymer material cured by:
enclosing the polymer material within an envelope;
reducing an interior pressure within the envelope to a predetermined negative pressure;
inducing flow of the polymer material by increasing an exterior pressure to a predetermined flow pressure and a material temperature to a predetermined flow temperature;
curing the polymer material by increasing the exterior pressure to a predetermined cure pressure and the material temperature to a predetermined cure temperature and maintaining for a predetermined cure period;
degassing the polymer material by increasing the exterior pressure to a predetermined degas pressure and the material temperature to a predetermined degas temperature and maintaining for a predetermined degas period; and
cooling the polymer material.
